(19) United States
(12) Patent Application Publication
(10) Pub. No.: US 2005/0213523 A1
(43) Pub. Date: Sep. 29, 2005

(54) In-factory data control method and data control system

(75) Inventor: Satofumi Kinei, Soraku-gun (JP)

Correspondence Address: NIXON & VANDERHYE, PC, 901 NORTH GLEBE ROAD, 11TH FLOOR, ARLINGTON, VA, 22203, US

(73) Assignee: SHARP KABUSHIKI KAISHA, Osaka (JP)

(21) Appl. No.: 11/083,966

(22) Filed: Mar. 21, 2005

(30) Foreign Application Priority Data
Mar. 24, 2004 (JP) P2004-087102

(51) Int. Cl. G11B 20/10; G11B 15/52; H04B 7/00

(52) U.S. Cl. 370/310

(57) ABSTRACT

Provided is an in-factory data control system that, at a lower cost, can collect output data from a facility having no data transmitting function and data which is not object of automatic transmission, and carry out data control such as processing/analyzing of the collected data. In an in-factory data control system, data outputted to a data output section of a facility having a data output function, but no data transmitting function is inputted to a portable terminal which is portable, the inputted data is transmitted by wireless communication from the portable terminal to a host computer, and the data having received by the host computer is processed and/or analyzed.

### BACKGROUND OF THE INVENTION

1. Field of the Invention

The present invention relates to an in-factory data control method and data control system.

2. Description of the Related Art

In a factory which is provided with a large number of production facilities, it is necessary to control a large number of data such as data on operations of the facilities, in order to constantly produce products with stable quality. Taking a semiconductor manufacturing factory as an example, types of such data include a wide variety of data such as line widths in a photolithography process, film thicknesses before and after chemical vapor deposition (abbreviated to CVD) and an etching process, carrier concentration in an ion injection process and particle quantities of contaminant particles on wafers.

Further, data on operation records of production facilities, data on daily checks of facilities and data on operational environments of facilities are also important. Data on operation records of facilities includes, for instance, data on film forming temperatures and film forming pressures in a CVD process and data on etching time in an etching process. Data on daily checks for facilities includes, for example, a pressure of a pump attached to a CVD apparatus and data on illumination intensity of an exposure apparatus. Data on operational environments of facilities includes a temperature and a humidity of a clean room. Furthermore, data on process progress of wafers as products is also important.

By collecting these data and monitoring their changes with time, together with viewing them as needed, it is made possible to detect the occurrence of an abnormality at an early stage and to cope with the abnormality. Since the collection, processing and analyzing of data facilitate the statistical data control (Statistical Process Control: abbreviated to SPC) of process capability indices such as Cp and Cpk, they are very useful for improving manufacturing conditions and variations in product quality.

FIG. 4 is a drawing showing an example of a data control system in a semiconductor manufacturing factory. In FIG. 4, a Local Area Network (abbreviated to LAN) 2 to which a host computer 1 is connected is established, and a CVD apparatus 3, an etching apparatus 4, an exposure apparatus 5, a film thickness measuring apparatus 6, a carrier concentration measuring apparatus 7 and the like are connected to the LAN 2. The data control system shown in FIG. 4, the output data from each apparatus is transmitted to the host computer 1 through the LAN 2, and the collected data are processed/analyzed by the host computer 1, so that the data is used for SPC.

However, data to be controlled in a factory comes up to an enormous amount also in a semiconductor manufacturing factory as mentioned above. Accordingly, there is such a problem that it takes much time to collect the data and that data that can be processed/analyzed is limited in quantity.

As a related art to cope with such a problem, it is proposed that a second network to be located in a subordinate position to a first network to which a host apparatus is connected should be established, and that as a result of the data collection and data analysis carried out on the second network, the information only proved to be useful is transferred to the host apparatus through the first network, thereby controlling the manufacturing on the basis of the transferred information (see Japanese Unexamined Patent Publication JP-A 2003-114708).

As another related art, it is proposed that by providing a plurality of converter devices in a data transmission system, and via the converter devices, by carrying out wireless communication by using a high data transmission speed of 2.4 GHz band frequency between a terminal to be mountable or portable on a movable body and a wireless station, and by carrying out wireless communication by using a low data transmission speed of 400 MHz band frequency between the terminal and an assembling work site terminal, the speed for collecting data is improved (see Japanese Unexamined Patent Publication JP-A 2000-106570).

However, although the technologies disclosed in JP-A 2003-114708 and JP-A 2000-106570 can cope with such issues of effective handling of data and of improving speed of data collection, such problems as mentioned below cannot be solved.

In order to realize the technologies disclosed in JP-A 2003-114708 and JP-A 2000-106570, all the facilities to be equipped in a factory have to be provided with a data transmitting function, thus leading to a cost increase of investments in plant and equipment. Moreover, establishing anew a LAN to be used for transmitting data, whether wired or wireless, in the form of including the entire facilities to be equipped in a factory may often be extremely difficult task to be materialized in view of investment costs.

Data useful for SPC in a factory includes not only data outputted from facilities, but also a large number of data obtained visually by operators. In particular, abnormalities may be discovered from data obtained through daily checks for the facilities. It is, therefore, not practical, in terms of data control, to automatically transmit all the data from the facilities. Accordingly, it is a reality that inevitably there are hand-written data obtained visually by operators even in a factory where data is automatically transmitted from each facility.

When a facility provided in a factory does not have a data transmitting function, handwritten data is prepared by an operator from the data outputted from the facilities. FIGS. 5A and 5B are drawings illustrating handwritten data prepared from film thickness measuring results by use of a CVD apparatus. Referring to FIGS. 5A and 5B, output data, for instance, from a CVD apparatus will be explained. Film thickness data measured after a film formation are handwritten by an operator, who prepares a table 11 representing film thicknesses by production lot as shown in FIG. 5A. The data shown in the Table 11 is inputted manually to a personal computer (abbreviated to PC), and graphed by means of the personal computer as shown by the line 12 connecting filled circles represented in FIG. 5B. Further, the data shown in Table 11 may be graphed by being plotted in handwriting.

In JP-A 2003-114708 and JP-A 2000-106570, when the data to be controlled covers an enormous amount, this issue is dealt with in such manners as to limit the processing data quantity by hierarchizing a LAN and/or to improve the data transmission speed by changing communication frequencies. However, in the technologies disclosed in JP-A 2003-114708 and JP-A 2000-106570, basically using data transmitting function of the facilities, there is such a problem that when the handwritten data mentioned above has to be fallen back upon, there is nothing that can be done.

### SUMMARY OF THE INVENTION

Hence, the invention has been made in view of the actual situation mentioned above. It is an object of the invention to provide, an in-factory data control method and data control system that, at a lower cost, can collect data outputted from facilities having no data transmitting function and data which is not object of transmitting automatically and carry out the data control such as processing/analyzing.

The invention provides an in-factory data control method for process management in which data obtained from a facility provided in a factory is collected and processed and/or analyzed, the method comprising the steps of:
obtaining data from a facility having a data display function, but no data transmitting function;
inputting the obtained data to a portable input apparatus which is portable and can transmit data;
transmitting the data to a data processing apparatus by the portable input apparatus; and
processing and/or analyzing the data by the data processing apparatus.

In the invention, it is preferable that the step of transmitting the data to the data processing apparatus by the portable input apparatus is carried out by wireless communication.

In the invention, it is preferable that the step of transmitting the data to the data processing apparatus by the portable input apparatus is carried out by wire communication.

In the invention, it is preferable that the step of transmitting the data to the data processing apparatus by the portable input apparatus is carried out via an apparatus linked by wired connections to the data processing apparatus.

In the invention, it is preferable that the apparatus linked by wired connections is a cradle.

The invention provides an in-factory data control system for process management in which data obtained from a facility provided in a factory is collected and processed and/or analyzed, the in-factory data control system comprising a facility capable of displaying data, but not capable of transmitting data; a portable input apparatus into which data to be displayed by the facility is inputted, the portable input apparatus being portable and capable of transmitting data; and a data processing apparatus for receiving and processing and/or analyzing the data transmitted by the portable input apparatus.

Further, in the invention, it is preferable that the portable input apparatus is provided with wireless transmission section, the data processing apparatus is provided with wireless receiving section, and data transmission from the portable input apparatus to the data processing apparatus is carried out by wireless communication.

In the invention, it is preferable that data transmission from the portable input apparatus to the data processing apparatus is carried out by wire communication.

In the invention, it is preferable that the data processing apparatus is provided with an apparatus linked thereto by wired connections.

In the invention, it is preferable that the apparatus linked to the data processing apparatus by wired connections is a cradle.

According to the invention, data to be displayed by the facility having a data display function, but no data transmitting function is inputted to the portable input apparatus which is potable and can transmit data, is transmitted to the data processing apparatus by the portable input apparatus and is then processed and/or analyzed. In this way, data to be displayed by the facility is not automatically transmitted by the facility, but is once inputted to the portable input apparatus and then is transmitted from the portable input apparatus to the data processing apparatus. It is, therefore, not necessary to establish a LAN or the like for automatically transmitting data by linking the facility with the data processing apparatus. This can save the investment costs. Furthermore, data which not object of automatic transmission can be collected, inputted to the portable input apparatus, and transmitted to the data processing apparatus, where the data is processed/analyzed, so that the data can be used for SPC, thereby allowing a scrutinized data control.

Furthermore, according to the invention, data transmission by the portable input apparatus to the data processing apparatus is carried out by wireless communication. It is, therefore, possible to collect data displayed by facilities arranged in a wide area of a factory.

According to the invention, data transmission by the portable input apparatus to the data processing apparatus is carried out via wire communication, preferably an apparatus linked by wired connections to the data processing apparatus, more preferably a cradle. Accordingly, even in a case where the portable input apparatus is of a type that is not provided with a connector for connecting to the data processing apparatus, it can transmit data without any problem.

According to the invention, an in-factory data control system is provided at low investment costs which is capable of such data management that displayed data of facilities not having a data transmitting function and data which is not object of automatic transmission are collected and processed/analyzed.

### BRIEF DESCRIPTION OF THE DRAWINGS

Other and further objects, features, and advantages of the invention will be more explicit from the following detailed description taken with reference to the drawings wherein:

FIG. 1 is a block diagram showing schematically the constitution of an in-factory data control system according to a first embodiment of the invention;

FIG. 2 is a flow chart illustrating a data control method of the invention;

FIG. 3 is a perspective view showing schematically the constitution of a data processing apparatus provided in a data control system according to a second embodiment of the invention;

FIG. 4 is a drawing showing an example of the data control system in a semiconductor manufacturing factory; and

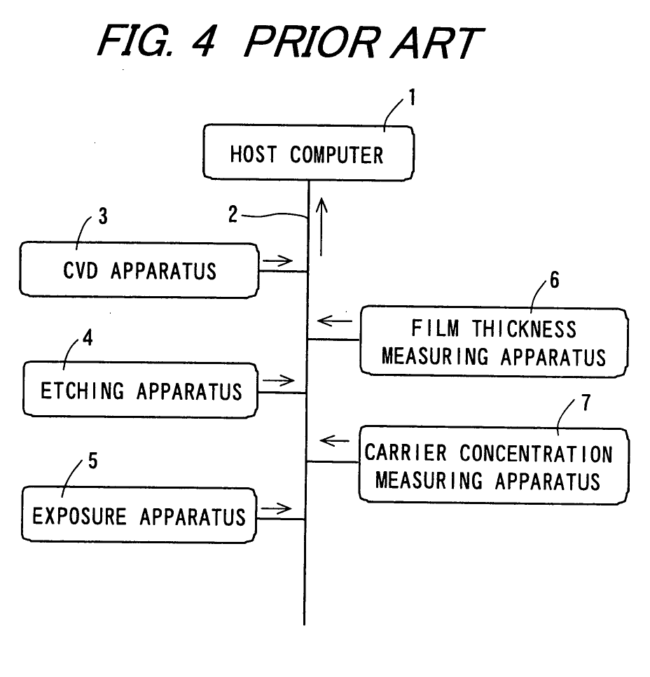

FIGS. 5A and 5B are drawings illustrating handwritten data prepared from film thickness measuring result by a CVD apparatus.

### DETAILED DESCRIPTION OF THE PREFERRED EMBODIMENTS

Now referring to the drawings, preferred embodiments of the invention are described below.

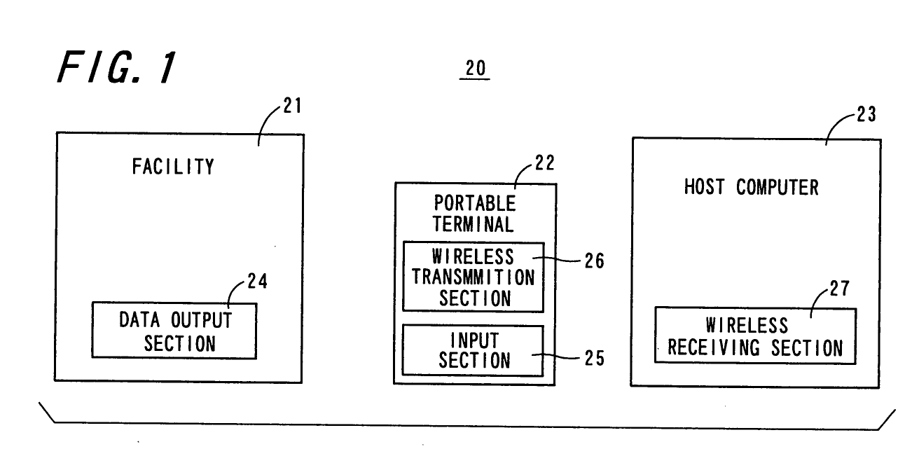

FIG. 1 is a block diagram showing schematically the constitution of an in-factory data control system 20 according to a first embodiment of the invention. The in-factory data control system 20 (hereinafter abbreviated to data control system 20) comprises a facility 21 having a data display function but no data transmitting function, a portable terminal 22, and a host computer 23. The portable terminal 22 is a portable input apparatus which is portable and can transmit data and into which data outputted by the facility 21 is inputted. The host computer 23 is a data processing apparatus for receiving data transmitted by the portable terminal 22 and processing and/or analyzing the data. The data control system 20 collects data obtained from the facility 21 provided in a factory and processes and/or analyzes the data for use in process control.

The facility 21 provided in a factory is not limited to a particular one. For instance, in a semiconductor manufacturing factory, such facilities include, for example, a plasma CVD apparatus, an etching apparatus, an exposure apparatus, a film thickness and refractive index measuring apparatus. The facility 21 is provided with a data output section 24 for displaying data. The data output section 24 is constituted by a liquid crystal display (abbreviated to LCD), a printer or the like. It is noted that the data output section 24 may be constituted in combination with an LCD and a printer. Data to be outputted in this data output section 24 includes various types of data according to types of the facility 21. For instance, in a case where the facility 21 is a CVD apparatus, such data includes film forming temperatures and RF outputs. In the case of the film thickness and refractive index measuring apparatus, such data includes film thickness and film refractive index.

The portable terminal 22 is provided with an input section 25 for inputting data and a wireless transmission section 26 for transmitting the inputted data to the host computer 23 by wireless communication. The input section 25 is formed by, for instance, a keyboard. Data input from the input section 25 to the portable terminal 22 is carried out by an operator. That is to say, the operator confirms data to be displayed on the data output section 24 in the facility 21 and types the data into the input section 25. For the wireless transmission section 26, a known wireless communication unit using radio-frequency waves can be used together with a wireless receiving section 27 which is provided in the host computer 23. As the wireless communication unit, there is also a wireless communication unit using infrared rays. However, since the transmission distance of the infrared rays is short, a wireless communication unit using radio-frequency waves are preferable. This is because it is possible to communicate in a wide area of a factory.

The portable terminal 22 converts data inputted from the input section 25 into digital signals, which can be transmitted by wireless communication from the wireless transmission section 26 to the host computer 23.

The host computer 23 is a processing circuit having a central processing unit (abbreviated to CPU) and a storage section which can store inputted data therein, for instance, a hard disc drive (abbreviated to HDD), and is realized by, for instance, a personal computer or a computer provided with a server function. The host computer 23 receives data to be transmitted from the portable terminal 22 and can carry out processing/analyzing such as arithmetic processing of data.

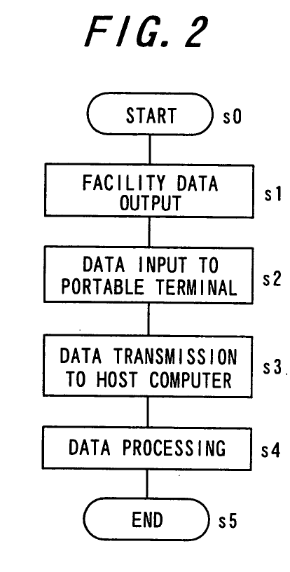

FIG. 2 is a flow chart for illustrating a data control method of the invention. Referring to FIG. 2, the data control method is explained. In this flow chart, as the facility 21, for instance, a film thickness measuring apparatus for measuring a thickness of a film formed on a wafer by means of a CVD apparatus is illustrated.

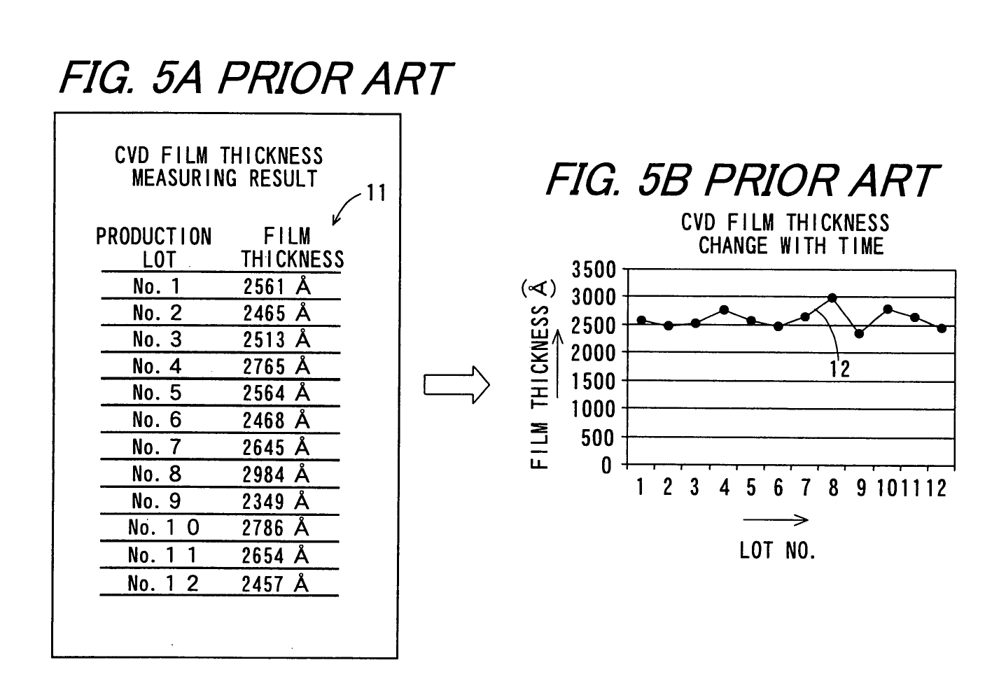

At the start in step s0, the film thickness measuring apparatus which is the facility 21 is operating for measuring a film thickness. In step s1, the film thickness measuring apparatus causes the data output section 24 to display as data the film thickness measuring result shown in FIG. 5A. In step s2, an operator inputs the film thickness measuring result as the displayed data into the portable terminal 22 from the input section 25.

In step s3, the portable terminal 22 transmits data by wireless communication from the wireless transmission section 26 to the wireless receiving section 27 of the host computer 23. In step s4, the host computer 23 which has received the data graphs out the film thickness measuring result as shown in FIG. 5B. The trend data graphed is outputted to an output apparatus (not shown) provided in the host computer 23, for instance, an LCD or a printer. Then the routine proceeds to step s5, and a series of data control is finished.

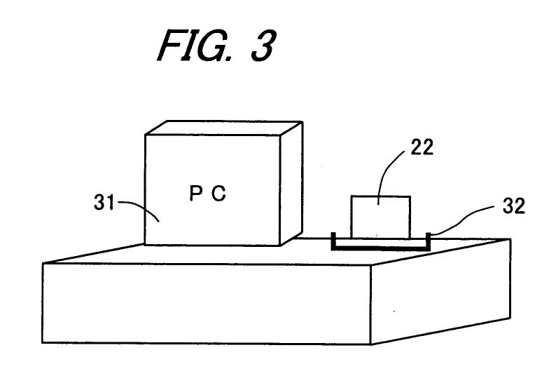

FIG. 3 is a perspective view showing schematically the constitution of a data processing apparatus 31 provided in a data control system according to a second embodiment of the invention. Since the data control system of this embodiment is constituted in the same manner as the data control system 20 of a first embodiment, except for the data processing apparatus 31, an overall view and the explanation of the same part will be omitted.

In the data control system of this embodiment, the data processing apparatus 31 is provided with an apparatus linked thereto by wired connections, preferably a cradle 32. The data control system 31 of this embodiment is constituted by a personal computer provided with an HDD as a storage section. In the personal computer 31, the cradle 32 which is a holder for connecting to the portable terminal 22 is provided. By connecting the portable terminal 22 having inputted data to the cradle, the data is transmitted from the portable terminal 22 to the personal computer 31 by wire communication. In this embodiment, the apparatus linked by wired connections to the data processing apparatus 31 is the cradle 32. However, the apparatus linked to the data processing apparatus 31 is not limited to the above, and the apparatus may be an apparatus which is linked to the portable terminal 22 and has a function of transmitting data to the data processing apparatus 31 by wire communication.

Although establishing a LAN in which a data transmitting function is provided in each facility in a factory and each facility and the data processing apparatus are connected to each other involves difficulty in terms of costs and expenses, it is relatively feasible to establish in a limited way a LAN to connect the data processing apparatuses 23, 31 and a superordinate computer. By providing a plurality of data processing apparatuses in a factory and connecting the plurality of data processing apparatuses and the superordinate computer by means of a LAN, it is made possible to further transmit data inputted to each data processing apparatus to the superordinate computer via the LAN, and thereby to control intensively data from a large number of facilities by the superordinate computer.

As mentioned above, the data examples in these embodiments show the output data involved in the operation of a facility. However, data referred to in the invention is not limited to the above data. Daily check data, for instance, the quantity of cooling water for an apparatus or the remaining quantity of a gas used as a material may be obtained and the obtained data may be inputted to the portable terminal for data control.

The invention may be embodied in other specific forms without departing from the spirit or essential characteristics thereof. The present embodiments are therefore to be considered in all respects as illustrative and not restrictive, the scope of the invention being indicated by the appended claims rather than by the foregoing description and all changes which come within the meaning and the range of equivalency of the claims are therefore intended to be embraced therein.

1. An in-factory data control method for process management in which data obtained from a facility provided in a factory is collected and processed and/or analyzed, the method comprising the steps of:
obtaining data from a facility having a data display function, but no data transmitting function;
inputting the obtained data to a portable input apparatus which is portable and can transmit data;
transmitting the data to a data processing apparatus by the portable input apparatus ; and
processing and/or analyzing the data by the data processing apparatus.

2. The in-factory data control method of claim 1, wherein the step of transmitting the data to the data processing apparatus by the portable input apparatus is carried out by wireless communication.

3. The in-factory data control method of claim 1, wherein the step of transmitting the data to the data processing apparatus by the portable input apparatus is carried out by wire communication.

4. The in-factory data control method of claim 1, wherein the step of transmitting the data to the data processing apparatus by the portable input apparatus is carried out via an apparatus linked by wired connections to the data processing apparatus.

5. The in-factory data control method of claim 4, wherein the apparatus linked by wired connections is a cradle.

6. An in-factory data control system for process management in which data obtained from a facility provided in a factory is collected and processed and/or analyzed, the in-factory data control system comprising:
a facility capable of displaying data, but not capable of transmitting data;
a portable input apparatus into which data to be displayed by the facility is inputted, the portable input apparatus being portable and capable of transmitting data; and
a data processing apparatus for receiving and processing and/or analyzing the data transmitted by the portable input apparatus.

7. The in-factory data control system of claim 6, wherein the portable input apparatus is provided with wireless transmission section,
the data processing apparatus is provided with wireless receiving section, and
data transmission from the portable input apparatus to the data processing apparatus is carried out by wireless communication.

8. The in-factory data control system of claim 6, wherein data transmission from the portable input apparatus to the data processing apparatus is carried out by wire communication.

9. The in-factory data control system of claim 6, wherein the data processing apparatus is provided with an apparatus linked thereto by wired connections.

10. The in-factory data control system of claim 9, wherein the apparatus linked to the data processing apparatus by wired connections is a cradle.
